(19) United States
(12) Patent Application Publication
(10) Pub. No.: US 2024/0342600 A1
(43) Pub. Date: Oct. 17, 2024

(54) SYNCHRONIZATION OF VIDEO RENDERING PIPELINES FOR LATENCY-SENSITIVE APPLICATIONS

(71) Applicant: NVIDIA Corporation, Santa Clara, CA (US)

(72) Inventors: Sau Yan Keith LI, San Jose, CA (US); Ziad Ben Hadj Alouane, San Jose, CA (US); Seth Schneider, San Jose, CA (US); Viktor Grigoryevich Vandanov, San Jose, CA (US); Rouslan Lyubomirov Dimitrov, Santa Clara, CA (US)

(21) Appl. No.: 18/529,260

(22) Filed: Dec. 5, 2023

Related U.S. Application Data
(60) Provisional application No. 63/460,022, filed on Apr. 17, 2023.

(51) Int. Cl. A63F 13/52; A63F 13/355

(52) U.S. Cl. CPC A63F 13/52; A63F 13/355

(57) ABSTRACT

Disclosed are apparatuses, systems, and techniques that eliminate frame tears, reduce stutters, and minimize latency in frame rendering pipelines. The techniques include but are not limited to collecting one or more latency metrics associated with rendering of a first set of one or more frames using a graphics rendering pipeline operating according to a first frame-generation schedule. The techniques further include modifying, using the one or more latency metrics, a first frame-generation schedule to obtain a second frame-generation schedule. The techniques include, rendering using the graphics rendering pipeline operating according to the second frame-generation schedule, a second set of one or more frames, and causing the second set of frames to be displayed on a display device.

### RELATED APPLICATIONS

This application claims the benefit of U.S. Provisional Patent Application No. 63/460,022, filed Apr. 17, 2023, entitled “Low Latency Vertical Synchronization for Streaming Software Applications,” which is incorporated by reference herein.

### TECHNICAL FIELD

At least one embodiment pertains to processing resources and techniques that are used to improve efficiency and decrease latency of data transfers in computational applications. For example, at least one embodiment pertains to facilitating efficient transfer of image and video data between computing devices in latency-sensitive applications, including streaming applications, such as video games or collaborative/distributed content creation applications.

### BACKGROUND

Modern gaming and/or streaming applications generate (render) and transfer a large number of frames within a short time, such as 60 frames per second (fps), 120 fps, or even more. The rendered frames are displayed on a screen (monitor) of a user's computer, which can be connected to the gaming or streaming application via a local bus or a network connection (e.g., in the instance of cloud-based applications). High frame rate, when matched by a refresh rate of the monitor, can provide greater immersion and responsiveness, and lead to a deeply enjoyable experience. Frames rendered by a gaming processor, however, have varying complexity, degree of similarity to other frames, and/or the like. As a result, the time used to render different frames may vary significantly. This can result in various visual artifacts, such as frame tears and stutters, which can ruin or significantly reduce the enjoyment of the application experience. A frame tear occurs when a new frame has been rendered and sent to the screen too early, so that one portion (e.g., bottom portion) of the screen displays the new frame while the rest of the screen still displays a previous frame. A stutter occurs when a new frame is rendered too late, so that a previously rendered frame has to be displayed instead, thus causing the gamer to momentarily experience a redundant frame. Frames that are not timely displayed clog the frame processing pipeline and further reduce the gaming or streaming experience.

### BRIEF DESCRIPTION OF DRAWINGS

FIG. 1 is a block diagram of an example system capable of eliminating frame tears, reducing stutters, and minimizing latency in a frame rendering pipeline used to support latency-sensitive applications, according to at least one embodiment;

FIG. 2 illustrates an example frame processing pipeline deploying the techniques that eliminate frame tears, reduce stutters, and minimize latency, according to at least one embodiment;

FIG. 3 is a timing diagram illustrating operations of a frame processing pipeline and metrics measured by a latency metric engine, according to at least one embodiment;

FIG. 4 is an example feedback loop that deploys latency tracking and frame rate control to eliminate frame tears, reduce stutters, and minimize latency in a frame rendering pipeline in latency-sensitive applications, according to at least one embodiment;

FIG. 5 is a flow diagram of an example method of using latency tracking and frame rate control to eliminate frame tears, reduce stutters, and minimize latency in a frame rendering pipeline, according to at least one embodiment;

FIG. 6 is a flow diagram of an example method of handling frame stutters by a frame rendering pipeline, according to at least one embodiment; and

FIG. 7 depicts a block diagram of an example computer device capable of supporting deployment of a frame processing pipeline that eliminates frame tears, reduces stutters, and minimizes latency, according to at least one embodiment.

### DETAILED DESCRIPTION

Vertical synchronization (VSync) techniques eliminate frame tears by limiting the rate at which rendered frames are provided to a display. For example, two frame buffers may be used to store rendered frames, so that while the display (or a display driver) reads frame data from a first buffer that is marked as a front buffer, an image rendering engine populates a second buffer, marked as a back buffer, with data for the next frame. After the display finishes reading the first buffer, a pause in reading—a Vertical Blank or VBlank—occurs before the display begins reading the next frame. During this VBlank pause, the frame rendering software flips the designations of the two buffers (e.g., marking the first buffer as the back buffer and marking the second buffer as the front buffer) and the display reads the new frame from the new front buffer. Although VSync eliminates tears, it does not prevent stutters. VSync also includes significant drawbacks; for example usage of Vsync can increase latency and create back pressure on the image rendering pipeline, which causes the rendered frames to spend more time (on average) in the display queue.

Fast synchronization (FastSync) is another technique that eliminates such clogging of the pipeline and reduces the back pressure by deploying more than two buffers to capture images generated by the image rendering engine at a native pace of the rendering engine. When multiple frames are available for displaying at a particular VBlank period, FastSync marks the buffer with the most recent frame as the front buffer and discards older frames. However, since the number of discarded frames is not consistent across the duration of the game, FastSync comes at the cost of degraded smoothness and still does not eliminate stutters. GSync® operates from the other end of the frame rendering pipeline by matching the refresh rate of the display to that of the image rendering engine, essentially operating as a variable refresh rate (VRR) display. When the frame rate of the image rendering engine falls below the refresh rate, GSync®/VRR ensures a smooth viewing experience, but handling of the frame rates in excess of the display refresh rate still remains a challenge.

Aspects and embodiments of the instant disclosure address these and other technological challenges by providing for methods and systems that decrease latency in latency-sensitive applications (including but not limited to gaming applications) while significantly reducing occurrences of both frame tears and stutters and improving overall user experience. More specifically, a latency tracking engine (LTE) may track various metrics representative of temporal dynamics of various processes occurring in the frame processing pipeline, which starts with a specific application and ends with a monitor displaying a stream of images generated by the application. The frame processing pipeline includes various hardware components (CPUs, GPUs, network controllers, etc.) and software modules (encoders/decoders, packetizers/depacketizers, drivers, etc.). The LTE is capable of measuring timing between various pipeline events, e.g., a time between a CPU outputting an instruction to a GPU to render a specific frame and a time the display begins displaying the frame to the user. At the initialization of the application, the LTE may determine the display's refresh rate f (which may be fixed by the display), and the application software may set a minimum interval T_{MIN} between rendering of consecutive frames in view of the display's refresh rate. The initial (e.g., average) minimum frame interval (MFI) may be set to T_{MIN}=f⁻¹. Subsequently, the LTE may monitor a time T_{Q} spent by various frames in a queue (referred to as time-in-queue or TiQ herein), e.g., time that passes after the frame is rendered and placed in a frame buffer and before the frame is displayed on the screen. The frame rendering pipeline may set a target TiQ T₀. In one illustrative example, T₀ may be one half of the inverse refresh rate,

$${T}_{0} = \frac{1}{2} {f}^{- 1} .$$

In some embodiments, the target TiQ T₀ may be set in conjunction with various processing times of the pipeline. For example, individual frame processing may be configured in such a way that the total estimated latency time T_{Tot}=T_{Proc}+T₀ ends at or near the middle of the VBlank interval. Time T_{Tot} is the sum of a processing time T_{Proc} (e.g., a combined time for CPU to generate frame rendering instructions and for the GPU to render the frame) and the target TiQ T₀. The target T₀ can be set to reduce T_{Tot}, on one hand, while not being so low as to cause frequent stutters. The LTE may further monitor whether individual frames are rendered in time to a respective target (for that frame) VBlank interval or miss the respective target VBlank interval (causing stutters). In those instances where a percentage of frames missing target VBlank internals is above a certain target percentage, the target TiQ T₀ may be increased.

The time in queue T_{Q} (or, in some embodiments, times T_{Proc}, and/or T_{Q}) can be measured by the LTE and used, by a frame rate controller, to dynamically adjust various controllable times of the pipeline. The time T_{Proc} may be beyond the pipeline's control and may depend on a particular frame content to be rendered. For example, a frame whose major portion is a uniform background (e.g., sky) or a frame that is similar to a previous frame may be rendered relatively quickly whereas a frame with many fast-moving objects that change quickly in appearance may take a significantly longer time to render. In contrast, the target TiQ T₀ as well as the starting time for T_{Proc} can be controlled to minimize the overall latency and maximize the efficiency of the rendering process. In particular, the LTE may monitor the actual TiQ T_{Q} (e.g, for one or more latest frames) and compute the difference ΔT=T_{Q}−T₀ between the actual TiQ and the target TiQ. When the time difference is positive (ΔT>0), meaning that the frames are rendered too early, the feedback loop may cause the frame processing to occur later, e.g., delaying the start of CPU and/or GPU processing by increasing the MFI T_{MIN} above the average MFI. Likewise, when the time difference is negative (ΔT<0), meaning that the frames are rendered late, the feedback loop may cause the frame processing to occur earlier, e.g., by reducing the MFI T_{MIN} above the average MFI. For example, a positive or negative time difference ΔT may be spread over n frames (e.g., three, five, ten, or some other number of frames) by adjusting the MFI, e.g., T_{MIN}→T_{MIN}−ΔT/n, such that for positive ΔT>0 (actual TiQ above the target TiQ) the next n frames are rendered faster and for negative ΔT<0 (actual TiQ below the target TiQ) the next n frames are rendered slower. This causes the frame rendering process to return to the target (ΔT≈0) after rendering and displaying the next n frames.

In those instances, where a stutter occurs, meaning that a frame X, intended to be displayed for a specific target VBlank interval VB_{X}, is rendered over such time T_{Proc} that the frame rendering concludes after the target VBlank VB_{X} interval ends, e.g.,

$$Δ T < - \frac{1}{2} {f}^{- 1} ,$$

the display reads the previous frame again Unlike conventional VSync handling of stutters (where target VBlank intervals shift forward, such that the late frame X is now targeted for VB_{X+1}, frame X+1 is targeted for VB_{X+2}, and so on), in the embodiments of the instant disclosure, shifting of VBlank intervals may occur temporarily, until an increased pace of the frame rendering process causes a transition from negative time differences,

$$Δ T < - \frac{1}{2} {f}^{- 1} ,$$

to positive time differences, ΔT>0. After the recovery, a frame may be dropped, so that the temporary VBlank shifting X+j→VB_{X+j+1} is remapped to the original schedule X+j→VB_{X+j}. More specifically, the negative time interval

$$Δ T < - \frac{1}{2} f$$

may be spread over N frames by reducing the MFI, e.g., T_{MIN}→T_{MIN}−|ΔT|/N. After rendering and displaying these next N frames, a frame (e.g., N+1th frame) may be dropped and the MFI may be increased, e.g., to the pre-stutter value. In some implementations, e.g., due to additional delays (e.g., network transmission delays, etc.), a frame may be rendered early enough in time, such that

$$Δ T > - \frac{1}{2} {f}^{- 1} ,$$

but the frame may still miss the end of the intended VBlank interval. In such instances, the LTE may detect the resulting frame stutter and may initiate the above-described remedial procedure of reducing the MFI interval.

The above, or similar, adjustments of the target TiQ may be performed periodically, e.g., once every 0.1 sec or more frequently, to respond efficiently to changing graphics of the application (e.g., game scenes). The advantages of the disclosed techniques include but are not limited to reducing or minimizing latency of a frame rendering pipeline, such as decreasing time spent by frames in the post-rendering queue, eliminating frame tears, and reducing stutter occurrences. This improves the application's performance and the overall user experience.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) (which may process text, voice, image, and/or other data types to generate outputs in one or more formats), systems implemented at least partially using cloud computing resources, and/or other types of systems.

### System Architecture

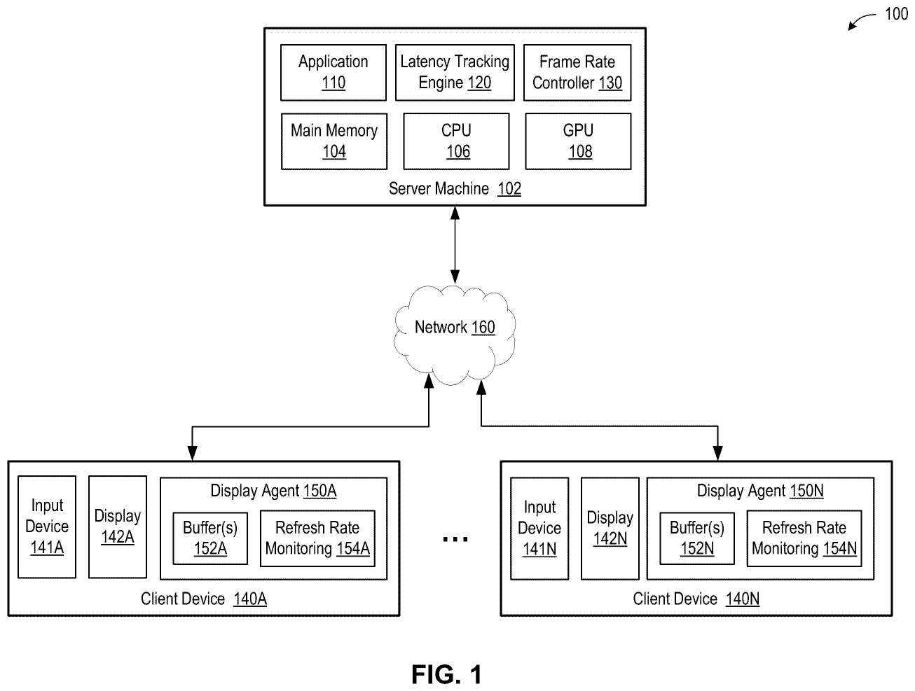

FIG. 1 is a block diagram of an example system 100 capable of eliminating frame tears, reducing stutters, and minimizing latency in a frame rendering pipeline used to support latency-sensitive applications, according to at least one embodiment. As depicted in FIG. 1, system 100 may include multiple computing devices, including a server machine 102 connected via a network 160 to client devices 140A . . . 140N. In one example embodiment, server machine 102 is a server of a cloud content delivery service (such as an application- or title-on-demand center or gaming-as-a-service center), e.g., a type of online gaming that runs a game application 110 remotely on one or more server machines 102 and streams game content directly to client devices 140A . . . 140N. Although a reference throughout this disclosure may often be made to gaming applications, application 110 may be or include any other application that renders and streams data to a device capable of displaying the data, e.g., client devices 140A . . . 140N. Although FIG. 1, for the sake of illustration, depicts client devices 140A . . . 140N that are communicating to server machine 102 via network 160, the techniques and embodiments of the instant disclosure are also applicable to applications 110 that are run on the same computer, e.g., a local computer that renders images and displays the rendered images on the local monitor.

Various processes and operations of application 110 may be executed and/or supported by a number of processing resources of server machine 102, including main memory 104, one or more central processing units (CPUs) 106, one or more graphics processing units (GPUS) 108, and/or various other components that are not explicitly illustrated in FIG. 1, such as wireless modems, network cards/controllers, local buses, graphics cards, parallel processing units (PPUs), data processing units (DPUs), accelerators, and the like.

Some or all client devices 140A . . . 140N may include respective input devices 141A . . . 141N and displays 142A . . . 142N. “Input device” may include any device capable of capturing a user input, such as a keyboard, mouse, gaming console, joystick, touchscreen, stylus, camera/microphone (to capture audiovisual inputs), and/or any other device that can detect a user input. The terms “monitor,” “display,” and “screen,” as used herein, should be understood to include any device from which images can be perceived by a user (e.g., gamer), such as an LCD monitor, LED monitor, CRT monitor, plasma monitor, and/or the like, including any monitor communicating with a computing device via an external cable (e.g., HDMI cable, VGA cable, DVI cable, DisplayPort cable, USB cable, and/or the like), or any monitor communicating with a computing device via an internal cable or bus (e.g., an all-in-one computer, a laptop computer, a tablet computer, a smartphone, and/or the like). “Monitor” should also include any augmented/mixed/virtual reality device (e.g., glasses), wearable device, and/or the like. In some embodiments, any, some, or all displays 142A . . . 142N may include a display with a fixed refresh rate display (e.g., a non-GSync®/VRR display).

Application 110 may cause server machine 102 to generate data (e.g., video frames) that is to be displayed on one or more displays 142A . . . 142N. A set of operations that begins with data generation and concludes with displaying the generated data is referred to as the frame rendering pipeline herein. Operations of the frame rendering pipeline may include operations performed by server machine 102, e.g., implementing a rendering stage, a capture stage, an encoding stage, a packetizer stage. The image rendering pipeline may also include a transmission stage that involves transmission of packets of data packetized by server machine 102 via network 160 (or any other suitable communication channel). The image rendering pipeline may further include operations performed by a client device 140X, such as operations of a depacketizer stage, a decoding stage, and a presentation stage. The operations of the image rendering pipeline on client device 140X may be supported by a display agent 150X.

The rendering stage may refer to the stage in the pipeline in which video frames (e.g., the video game output) are rendered on server machine 102 in accordance with a certain frame rate that may be set by a frame rate controller 130, e.g., as disclosed in more detail below. The frame capture stage may refer to the stage in the pipeline in which rendered frames are captured immediately after being rendered. The frame encoding stage may refer to the stage in the pipeline in which captured frames of the video are compressed using any suitable compressed video format, e.g, H.264, H.265, VP8, VP9, AV1, or any other suitable video codec formats. The frame packetizer stage may refer to the stage in the pipeline in which the compressed video format is partitioned into packets for transmission over network 160. The transmission stage may refer to the stage in the pipeline in which packets are transmitted to client device 140X. The frame depacketizer stage may refer to the stage in the pipeline in which the plurality of packets is assembled into the compressed video format on client device 140X. The frame decoding stage may refer to the stage in the pipeline in which the compressed video format is decompressed into the frames. The presentation stage may refer to the stage in the pipeline in which frames retrieved from buffer 152X are displayed on display 142X.

Some or all display agents 150A . . . 150N of respective client devices 140A . . . 140N may include a corresponding refresh rate monitoring component 154A . . . 154N that collects various metrics that characterize operations of the image rendering pipeline on the respective client device 140X. The metrics may include: an average refresh rate of display 142X, a noise (jitter) of the refresh rate of display 142X, an average duration and jitter of individual frames by display 142X, and/or specific timestamps corresponding to the times when display 142X begins displaying a particular frame, the times when display 142X finishes displaying that particular frame, and/or various other metrics. Metrics collected by the refresh rate monitoring component 154X on the side of client device 140X may be provided to a latency tracking engine (LTE) 120 on the server machine 102. LTE 120 may further collect various additional metrics on the side of the server machine 102, including but not limited to average and/or per-frame time for CPU/GPU processing T_{Proc}, average and/or per-frame time in queue (TiQ) To of the rendered frame (which may include time for packetizing/depacketizing of individual frames and time spent transmitting packets via network 160).

Metrics collected by LTE 120 may track frame processing at one, some, or all the stages of the image processing pipeline and may be used by frame rate controller 130 to pace frame rendering to minimize latency in frame processing along the pipeline, e.g., as disclosed in more detail below.

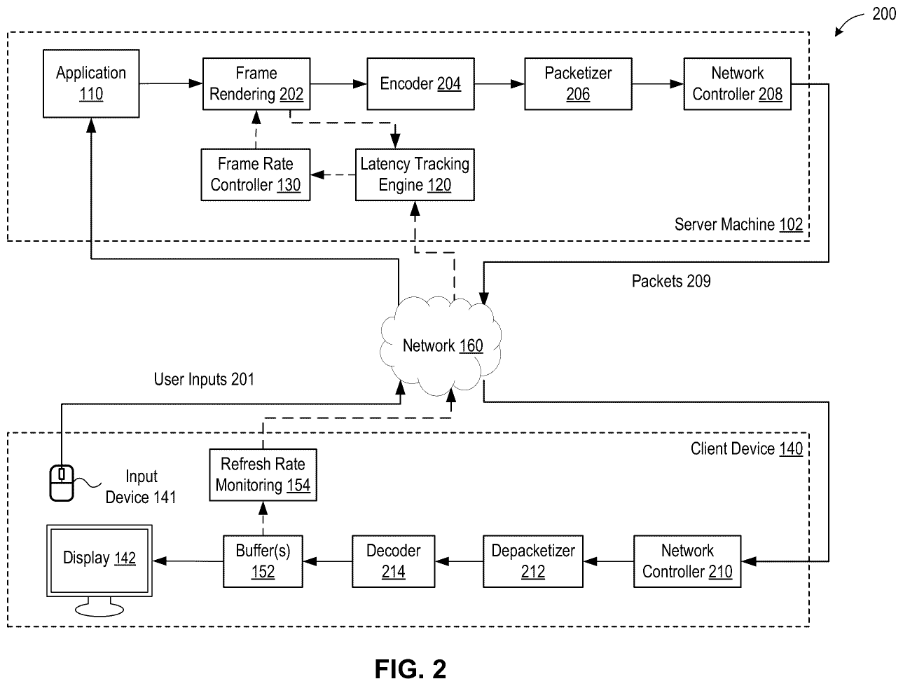

FIG. 2 illustrates an example frame processing pipeline 200 deploying the techniques that eliminate frame tears, reduce stutters, and minimize latency, according to at least one embodiment. Solid arrows in FIG. 2 indicate flow of application data (e.g., user-generated inputs, application-generated frames) while dashed arrows indicate metric collection and control operations of the pipeline. The image processing pipeline 200 may include application 110 (e.g., game application) operating on server machine 102. Application 110 configures frames to be rendered (e.g., using a GPU) and displayed on display 142 of client device 140. More specifically, application 110 may use a suitable application programming interface (API) that is run on a CPU of server machine 102 (e.g., CPU 106 in FIG. 1), with the CPU causing the GPU (e.g., GPU 108) to perform frame rendering 202 of a series of frames, e.g., frames of a video game. For example, the CPU may process user inputs 201 captured by input device 141 of client device 140, update the current state of application 110 (e.g., game), perform simulations of a new content (images/scenes/context) to be rendered (e.g., in view of specific distances traveled by various game objects, angles to which the objects have turned, and/or like), and generate rendering instructions for the GPU. The CPU may also manage a queue of instructions for the GPU to process, e.g., by keeping track of instructions that take too long to execute, eliminating instructions from the queue related to frames that are no longer relevant, and/or the like.

The rendered frames are then processed by an encoder 204. In one or more embodiments, encoder 204 may be a software implemented encoder or a dedicated hardware-accelerated encoder configured to encode data substantially compliant with one or more data encoding formats or standards, including, without limitation, H.263, H.264 (AVC), H.265 (HEVC), H.266, VVC, EVC, AVC, AV1, VP8, VP9, MPEG4, 3GP, MPEG2, and/or any other video or multimedia standard formats. Encoder 204 may encode individual rendered frames by converting the frames from a video game format to a digital format (e.g., H.264 format). Once the frame is rendered by encoder 204, packetizer 206 may packetize the encoded frame for transmission over network 160 via network controller 208 (network card, etc.). Packetizing the encoded frame may include partitioning the encoded frame into one or more packets 209 (e.g, formatted units of data) to be carried by network 160. Network controller 208 may transmit the packets 209 via network 160 to network controller 210 of client device 140. Due to various network conditions (e.g., network jitter), some of the packets 209 associated with a specific rendered frame may be lost during transmission or take longer to be transmitted to the client device 140. Depending on the embodiment, the lost packets may be recovered by client device 140 using error correction techniques, transmission retries, or other suitable methods of packet transmission and/or retransmission.

Client device 140 may receive the packets 209 that encode frames via a network controller 210 connected to network 160. The received packets may be processed by a depacketizer 212, a decoder 214, and buffer(s) 152. Depacketizer 212 may depacketize the packetized encoded frame to assemble the frame encoded by server machine 102 (e.g., encoder 204). Once the encoded frame is assembled, decoder 214 may decode the encoded frame. In one or more embodiments, decoder 214 may be a software-implemented decoder or a dedicated hardware-accelerated decoder decoding data according to the video encryption standard used by encoder 204. The decoded frame may be placed in one or more buffer(s) 152. In some embodiments, frame buffer(s) 152 may include a sufficient number of frames to ensure that the frames of application 110 (e.g., frames of the video game) are displayed at the desired frame rate.

In some embodiments, buffer(s) 152 may include at least two buffers, e.g., buffer A and buffer B. Buffer A and buffer B can be accessed by display 142 (or a display driver) independently. For example, buffer A, currently designated as a front buffer, may be used by display 142 to display a current frame. Concurrently, decoder 214 may populate buffer B with the next frame. Buffer B may be currently designated as a back buffer, e.g., a buffer that is not accessible to display 142. After display 142 completes reading buffer A, a VBlank pause in buffer reading may occur before display 142 begins reading the next frame. During the VSync pause, the display driver may flip the designations of the two buffers, designating buffer A as the back buffer (not currently accessible to display 142) and designating buffer B as the front buffer. Display 142 may then read the next frame from buffer B. The designations of the buffers may be flipped at the next VBlank pause. In some embodiments, buffers 152 may include additional buffers C, D, etc., which may be populated (and receive front buffer designations) sequentially, in a circular order. The image rendering pipeline 200 may minimize latency by reducing the amount of time that frames spend in the back buffer.

For example, refresh rate monitoring 154 may determine refresh rate f of display 142. Refresh rate f may remain fixed for the entire duration of application 110 (e.g., a gaming session) or for any portion of the duration of application 110. Based on the determined refresh rate, frame rendering 202 or application 110 may set a minimum interval T_{MIN} between rendering of consecutive frames in view of the display's refresh rate. For example, the initial minimum frame interval (MFI) may be set to T_{MIN}=f⁻¹ so that frames are expected to be paced, on average, with the correct frame rate that matches the refresh rate of the display.

During operations of application 110, LTE 120 may monitor time-in-queue (TiQ) To spent by individual frames in the queue, e.g., a time that elapses after a frame is rendered and before the frame is displayed on the screen (or a time that passes after the frame is placed in the buffer and before the frame is displayed on the screen). In some embodiments, TiQ monitoring may be performed for each frame. In some embodiments, TiQ monitoring may be performed according to some predetermined schedule, e.g., for every mth frame. Additional TiQ monitoring may be performed responsive to an occurrence of some triggering event, e.g., a departure of the last monitored TiQ from a target TiQ T₀, an occurrence of a frame stutter, and/or the like. In some embodiments, LTE 120 and refresh rate monitoring component 154 may be implemented as part of NVIDIA® Reflex or a similar tracking engine.

Frame rendering 202 (or application 110) may set the target TiQ T₀ based on the inverse refresh rate, e.g.,

$${T}_{0} = \frac{1}{2} {f}^{- 1}$$

or some other fraction of the inverse refresh rate f⁻¹ (e.g., one third, one quarter, etc.). For example, if the refresh rate of the display is 60.0 Hz, the inverse refresh rate (a time allocated, on average, to the presentation of a single frame, including a duration of a VBlank interval) can be f⁻¹=16.7 ms. Correspondingly, the target TiQ may be set to T₀=8.3 ms, in one example embodiment.

The set target TiQ T₀ may further be used by frame rendering 202 (or application 110) to pace the beginning of CPU/GPU processing in such a way as to bring the actual TiQ T_{Q} to the target TiQ T₀ as close as possible. For example, rate controller 130 (or application 110) may estimate an average processing time T_{Proc} (e.g., a combined time for the CPU to generate frame rendering instructions and for the GPU to render the corresponding frame) for a specific type of application 110 (e.g., gaming application, media streaming application, etc.). Frame rate controller 130 (or application 110) may then estimate the total latency time to be (on average) T_{Tot}=T_{Proc}+T₀ and configure a start of CPU/GPU frame processing (frame rendering) so that the end of the estimated interval T_{Tot} is at or near the middle of a VBlank interval. Target TiQ T₀ can be used to control T_{Tot}. In particular, smaller target TiQs lead to reduced latency while larger target TiQs are more efficient in preventing stutters. Setting an optimal target TiQ T₀, therefore, may be performed empirically, e.g., by testing various values T₀ for specific applications 110. Correspondingly, the target TiQ T₀ and the starting time for the processing interval T_{Proc} can be controlled to minimize the overall latency and maximize the efficiency of the rendering process.

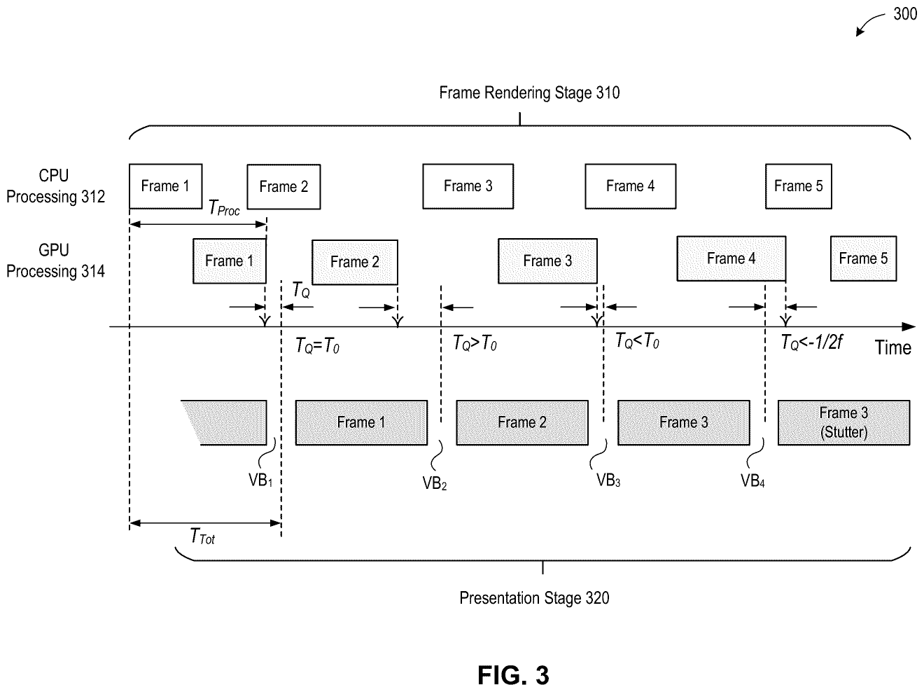

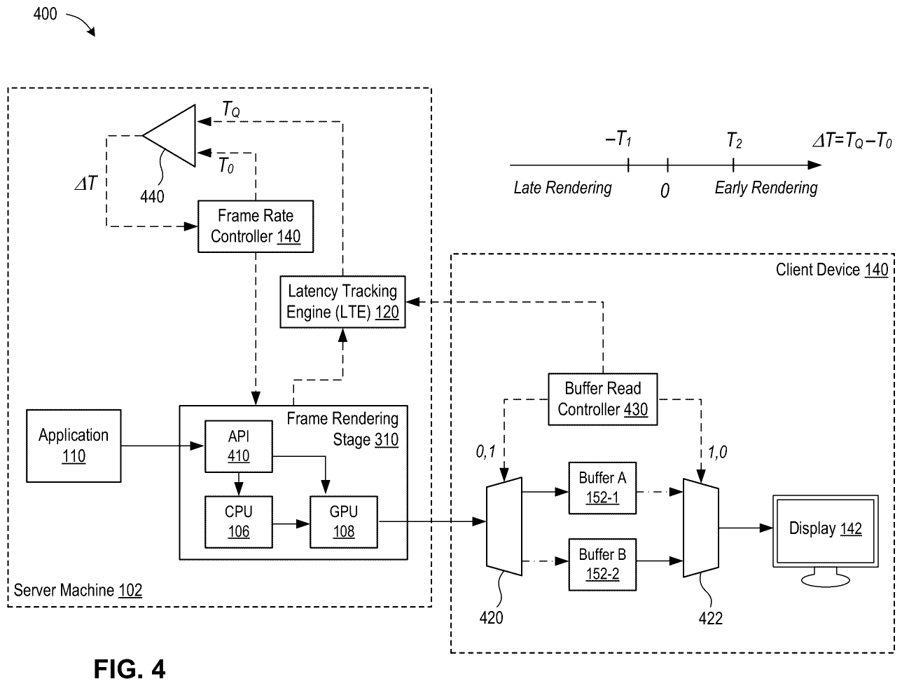

The actual time T_{Proc} may vary from frame to frame, e.g., with some frames rendered faster than the average estimated T_{Proc} and other frames rendered slower than the average. To respond to such variations, LTE 120 may monitor the actual TiQ T_{Q}, compute the difference ΔT=T_{Q}−T₀ between the actual TiQ and the target TiQ, and use this difference ΔT to control frame processing, e.g., as disclosed in more detail below in conjunction with FIG. 3 and FIG. 4. In one embodiment, frame rate controller 130 can react to the state of frame buffer 152 (with reference to FIG. 1) and dynamically adjust frame processing/rendering by application 110 via implementing a control loop mechanism that determines the difference ΔT and applies a mitigating correction at the rendering stage of the image processing pipeline.

FIG. 3 is a timing diagram illustrating operations 300 of a frame processing pipeline and metrics measured by a latency metric engine, according to at least one embodiment. Operations 300 include operations of a frame rendering stage 310 (which may be performed on the server machine side) and a presentation stage 320 (which may be performed on the client device side). The frame rendering stage 310 may include CPU processing 312 and GPU processing 314, illustrated via example rendered Frames 1-5. Processing operations are depicted via the rectangles whose horizontal extent illustrates schematically a duration of the respective operations. Similarly, presentation stage 320 includes displaying various rendered frames on a display of the client device, with the duration of displaying similarly represented by the horizontal extent of the respective rectangles and determined by a set refresh rate of the display. Presentation of individual frames Frame 1, Frame 2, etc., is interspersed with quiet periods, VBlank-1, VBlank-2, etc., where no frame data is drawn from display buffer(s).

Operations of frame rendering stage 310 may be illustrated using an example of Frame 1. As depicted, processing of Frame 1 begins with CPU processing 312 (e.g., generating instructions for the GPU). Following completion of CPU processing 312 (or near completion of CPU processing 312), GPU processing 314 of Frame 1 may commence (e.g., rendering Frame 1 using instructions generated by the CPU). CPU/GPU processing time T_{Proc} varies from frame to frame, e.g, depending on the visual complexity of the frame and similarity/dissimilarity to earlier frames. After Frame 1 has been rendered by the GPU, the frame is placed in a queue for presentation on the display of the client device. Time in queue T_{Q} (which may include time of network transmission) begins at the end of frame rendering and ends at some reference time associated with the corresponding VBlank period VB₁, e.g., the middle of VB₁ (as shown), the beginning of VB₁, the end of VB₁, and/or the like.

Frame 1 illustrates, schematically, a situation where ΔT=T_{Q}−T₀=0, e.g., when the actual TiQ T_{Q} is the same as target TiQ T₀. Frame 2 illustrates a situation where the time difference is positive (ΔT=T_{Q}−T₀>0), meaning that Frame 2 is rendered too early. Having detected that Frame 2 is an early frame, frame rate controller 130 may cause CPU/GPU processing of subsequent frames to occur later, e.g., by increasing the minimum frame interval (MFI) T_{MIN}. Frame 3 illustrates a situation where the time difference is negative (ΔT=T_{Q}−T₀<0), meaning that Frame 3 is rendered too late. As illustrated, Frame 3 may take longer to render and may, therefore, be ready closer to the presentation time (e.g., middle of VB₃ interval) than either Frame 1 or Frame 2. Having detected that Frame 3 is a late frame, frame rate controller 130 may cause CPU/GPU processing of subsequent frames to occur later, e.g., by decreasing the MFI T_{MIN}.

A positive ΔT>0 or negative ΔT<0 time difference may be spread over n frames (e.g., three, five, ten, or some other number) by adjusting the MFI, e.g., T_{MIN}→T_{MIN}−ΔT/n, such that for positive ΔT>0 (actual TiQ above target TiQ) the next n frames are rendered earlier and/or faster and for negative ΔT<0 (actual TiQ below target TiQ) the next n frames are rendered later and/or slower. This causes the frame rendering process to return to ΔT≈0 after rendering and displaying the next n frames. If frame rendering experiences a significant change of pace before the next n frames are rendered (e.g., due to a change in the game's scenery), the MFI T_{MIN} can be readjusted. Early or late frame rendering may be controlled by controlling the start time of CPU processing 312, or GPU processing 314, or both without changing the duration of the frame processing. Slower or faster frame rendering may be controlled by controlling the size of the frames (e.g., image quality/resolution of the frames), e.g., when rendered frames consistently miss the target TiQ, the image rendering application may reduce image resolution.

As another example, Frame 4 may have been rendered so late, e.g.,

$$Δ T < - \frac{1}{2} {f}^{- 1} ,$$

as to cause a stutter, meaning that Frame 4 has missed the end of VB₄ interval and the display continued the presentation of Frame 3 for an extra period of time. In the instances of stutters, e.g., when Frame X, intended to be displayed for a specific target VBlank interval VB_{X}, is rendered over such time T_{Proc} that the frame rendering concludes after the target VBlank VB_{X} interval ends and the display continues presentation of an earlier frame, a special procedure can be followed. In some embodiments, frame rate controller 130 may shift mapping of subsequent VBlank intervals, e.g., the late Frame X may now be targeted for presentation after VB_{X+1}, frame X+1 may be targeted for VB_{X+2}, and so on. This re-mapping may be temporary, and may be accompanied by an increased pace of the frame rendering until the initial negative time difference,

$$Δ T < - \frac{1}{2} {f}^{- 1}$$

(or, in some embodiments,

$$Δ T < - \frac{1}{2} ( {f}^{- 1} + {τ}_{VB} ) ,$$

where τ_{VB} is the duration of VBlank period) is corrected to neutral time difference ΔT≈0 or even overcorrected to slightly positive time difference, ΔT≥δT. After such recovery, a frame (e.g., the next frame after recovery) may be dropped, so that the temporary VBlank shifting X+j→VB_{X+j+1} is remapped back to the original schedule X+j→VB_{X+j}. For example, to accomplish the correction, the negative time interval

$$Δ T < - \frac{1}{2} f$$

may be spread over N frames by reducing the MFI, e.g., T_{MIN}→T_{MIN}−|ΔT|/N, for the N next frames. After rendering and displaying these N frames, a frame (e.g., N+1th frame) may be dropped and the MFI may be increased, e.g., to the pre-stutter value.

FIG. 4 is an example feedback loop 400 that deploys latency tracking and frame rate control to eliminate frame tears, reduce stutters, and minimize latency in a frame rendering pipeline in latency-sensitive applications, according to at least one embodiment. As illustrated, frame rendering stage 310 receives information about content of the frames to be rendered via API 410, which causes CPU 106 and GPU 108 to perform the corresponding CPU processing and GPU processing to render a stream of frames (as illustrated in conjunction with FIG. 3 above) to be displayed on display 142 of client device 140. Additional operations of the frame processing pipeline (encoding/decoding, packetizing/depacketizing, network controller operations, and/or the like) are omitted in FIG. 4 for brevity and conciseness.

A system that includes a demultiplexer 420 and a multiplexer 422 may deliver the rendered and transmitted frames to display 142 in a way that eliminates frame tears. More specifically, a buffer read controller 430 outputs control signals (0 or 1) that configure demultiplexer 420 and multiplexer 422 into one of a plurality of multiple configurations. In a first configuration (solid arrows) demultiplexer 420 provides a new rendered frame to buffer A 152-1 (back buffer) while multiplexer 422 passes a previously rendered frame from buffer B 152-2 (front buffer) to display 142. In a second configuration (dash-dotted arrows) demultiplexer 420 provides a new rendered frame to buffer B 152-2 (back buffer) while multiplexer 422 passes a previously rendered frame from buffer A 152-1 (front buffer) to display 142. Flipping from the first configuration to the second configuration and back happens when buffer read controller 430 swaps control signals (0↔1) delivered to the multiplexers/demultiplexers. Although the embodiment in FIG. 4 illustrates the front/back buffers implemented with hardware devices, e.g., multiplexers/demultiplexers, it should be understood that a similar functionality may be achieved via pure software switching between memory addresses of internal memory of display 142.

Latency tracking engine 120 may monitor various metrics, e.g., as illustrated above in FIG. 4 and/or other suitable metrics. In particular, latency tracking engine 120 may measure TiQ T_{Q} for one or more frames and use the measured TiQ(s) as an input into a comparator 440. A second input into comparator 440 may include the target time TiQ T₀ set by frame rate controller 140. Comparator 440 may determine a difference ΔT=T_{Q}−T₀ between the actual TiQ and the target TiQ and provide the computed difference to frame rate controller 130. When the time difference is positive (ΔT>0) and the frames are rendered too early, frame rate controller 130 may cause frame rendering stage 310 to delay initiation of frame processing (e.g., CPU processing 312). On the other hand, when the time difference is negative (ΔT<0) and the frames are rendered late, frame rate controller 140 may cause frame rendering stage 310 to accelerate the frame processing. In some embodiments, changes to the frame rendering may be implemented provided that the TiQ T₀ is outside an interval of minimal departures from the target TiQ, e.g., ΔT∉[−T₁, T₂], where T₁ is a minimum actionable departure for late-rendered frames, and T₂ is a minimum actionable departure for early-rendered frames. In some embodiments, T₁ may be the same as T₂; in other embodiments, the two minimum departure times may be different, e.g., late-rendering may be actionable for smaller departures than early rendering, T₁<T₂. In those instances where a stutter occurs, e.g., such that T_{Q}<−T₀, frame processing may be accelerated even more, e.g., as disclosed above in conjunction with FIG. 4.

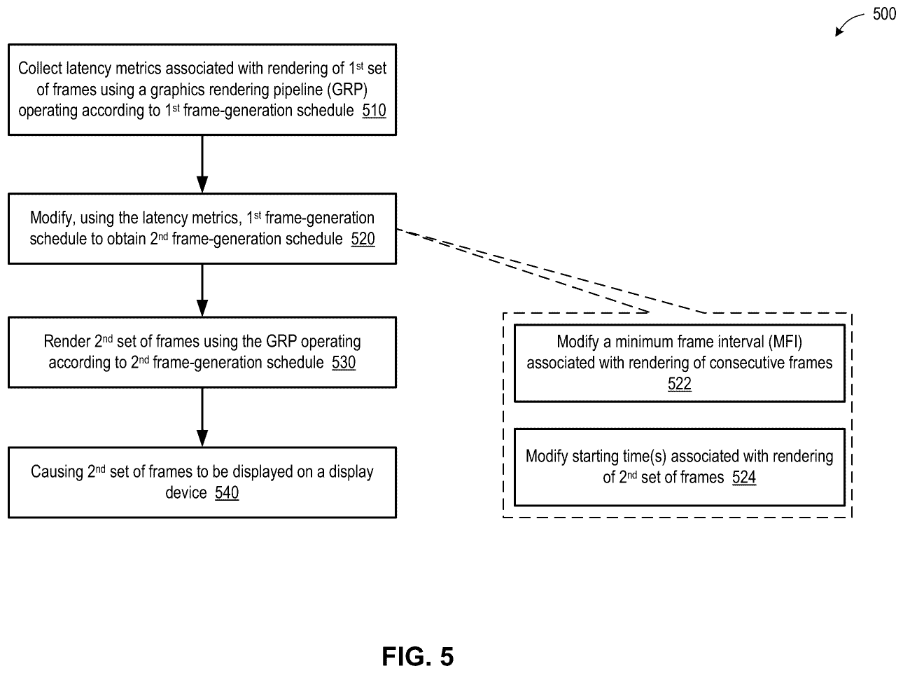

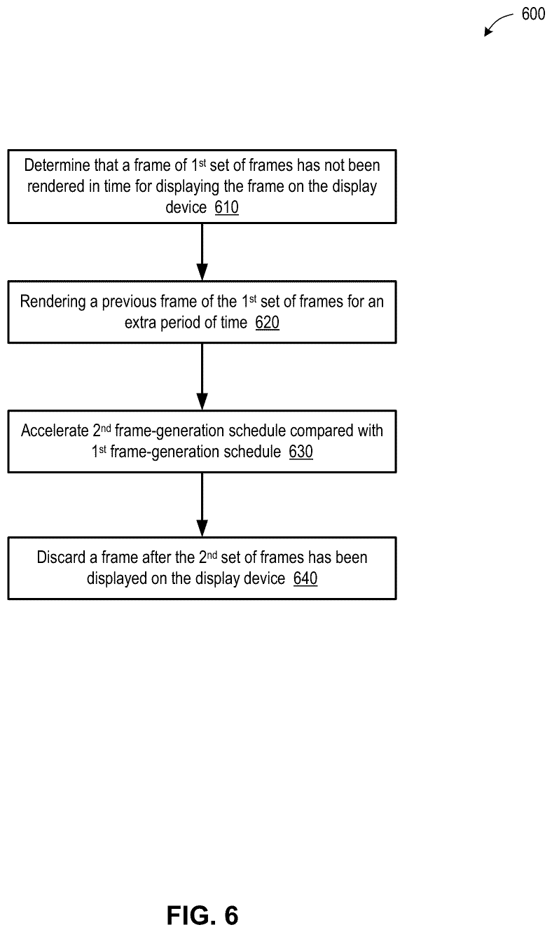

FIGS. 5 and 6 are flow diagrams of example methods 500 and 600 of deployment of a frame processing pipeline deploying the techniques that eliminate frame tears, reduce stutters, and minimize latency, according to some embodiments of the present disclosure. Methods 500 and/or 600 may be performed in the context of any suitable video applications, including local applications and cloud-based applications, such as gaming applications, video streaming applications, autonomous driving applications, surveillance applications, manufacturing control applications, retail control applications, virtual reality or augmented reality services, chatbot applications, and many other contexts, as well as systems and applications for providing one or more of such services. Methods 500 and/or 600 may be performed using one or more processing units (e.g., CPUs, GPUs, accelerators, PPUs, DPUs, etc.), which may include (or communicate with) one or more memory devices. In at least one embodiment, methods 500 and/or 600 may be performed using various components and devices illustrated in FIG. 1, e.g., server machine 102, one or more client devices 140A . . . 140N, and/or the like. In at least one embodiment, processing units performing methods 500 and/or 600 may be executing instructions stored on a non-transient computer-readable storage media. In at least one embodiment, methods 500 and/or 600 may be performed using multiple processing threads (e.g., CPU threads and/or GPU threads), individual threads executing one or more individual functions, routines, subroutines, or operations of the method. In at least one embodiment, processing threads implementing methods 500 and/or 600 may be synchronized (e.g., using semaphores, critical sections, and/or other thread synchronization mechanisms). Alternatively, processing threads implementing methods 500 and/or 600 may be executed asynchronously with respect to each other. Various operations of methods 500 and/or 600 may be performed in a different order compared with the order shown in FIG. 5 and/or FIG. 6. Some operations of methods 500 and/or 600 may be performed concurrently with other operations. In at least one embodiment, one or more operations shown in FIG. 5 and/or FIG. 6 may not always be performed.

FIG. 5 is a flow diagram of an example method 500 of using latency tracking and frame rate control to eliminate frame tears, reduce stutters, and minimize latency in a frame rendering pipeline, according to at least one embodiment. At block 510, method 500 may include collecting one or more latency metrics associated with rendering of a first set of one or more frames. The rendering of the first set of one or more frames can be performed using a graphics rendering pipeline operating according to a first frame-generation schedule. The first set of frames can be rendered by any suitable application, e.g., a gaming application, a streaming application, a content streaming application, a collaborative content creation application, and/or the like. The first set of frames can be any set of frames rendered during an application session, e.g., rendered at the start of the application session or at any point of the application session.

In some embodiments, the first frame-generation schedule may include a target time-in-queue T₀ for the first set of one or more frames. In some embodiments, the target time-in-queue may be determined in relation to an inverse refresh rate of the display device (e.g., as some fraction of the inverse refresh rate).

In some embodiments, the graphics rendering pipeline may include an application, one or more processing devices (e.g., CPU(s)/GPU(s)/PPU(s)/etc.), one or more network controllers, a plurality of buffers (e.g., to store rendered and received frames), a display device, and a controller configured to cause a rendered frame to be provided, to the display device, from an individual buffer from the plurality of buffers Providing the frame may be conditional on the frame being fully stored in the individual buffer. In some embodiments, the first frame-generation schedule may be determined based at least on a refresh rate of the display device and may include, e.g., a minimum frame interval (MFI) between the start of processing of two consecutive frames.

In some embodiments, the obtained latency metrics may include, for at least one of the one or more frames of the first set of frames, a time-in-queue TiQ T₀ associated with a delay between rendering a frame and displaying the respective frame. In some embodiments, the obtained latency metrics may further include a duration of processing T_{Proc} associated with rendering the respective frame.

At block 520, method 500 may continue with modifying, using the one or more latency metrics, a first frame-generation schedule to obtain a second frame-generation schedule. As illustrated with the callout portion of FIG. 5, modifying the first frame-generation schedule to obtain the second frame-generation schedule may include, at block 522, modifying, using a difference between the measured time-in-queue and the target time-in-queue (e.g., ΔT=T_{Q}−T₀), a minimum interval associated with rendering of consecutive frames of the second set of one or more frames. For example, the minimum interval may be adjusted based on (i) the difference ΔT and/or a number of frames of an adjustment period, e.g., the number of frames n over which the difference ΔT is to be adjusted, with ΔT/n adjustment to be performed per frame of the adjustment period. In some embodiments, modifying the first frame-generation schedule to obtain the second frame-generation schedule may further include, at block 524, modifying one or more starting times associated with rendering of the second set of one or more frames (e.g., a starting time for the CPU to generate frame rendering instructions). In some embodiments, modifying the first frame-generation schedule to obtain the second frame-generation schedule may further include modifying frame quality and/or resolution.

At block 530, method 500 may continue with rendering, using the graphics rendering pipeline operating according to the second frame-generation schedule, a second set of one or more frames. The second set of frames may be associated with the same application that generated the first set of frames. At block 540, method 500 may include causing the second set of frames to be displayed on a display device.

FIG. 6 is a flow diagram of an example method 600 of handling frame stutters by a frame rendering pipeline, according to at least one embodiment. In some embodiments, method 600 may be performed together with method 500. Method 600 may include, at block 610, determining that a frame of the first set of frames has not been rendered in time for displaying on the display device (see, e.g., Frame 4 in FIG. 3, for an illustration). At block 620, method 600 may continue with rendering a previous frame of the first set of frames for an extra period of time (e.g., Frame 3 in FIG. 3). At block 630, method 600 may include accelerating the second frame-generation schedule compared with the first frame-generation schedule (e.g., decreasing the MFI of the second schedule, compared with the MFI of the first schedule, reducing frame quality/resolution, and/or the like). At block 640, method 600 can include discarding a frame after the second set of one or more frames has been displayed on the display device. For example, the negative time difference ΔT may be spread over N frames with the time |ΔT|/N subtracted from the MFI to let the frame rendering pipeline to catch up and compensate for the delay that was caused by the stutter frame.

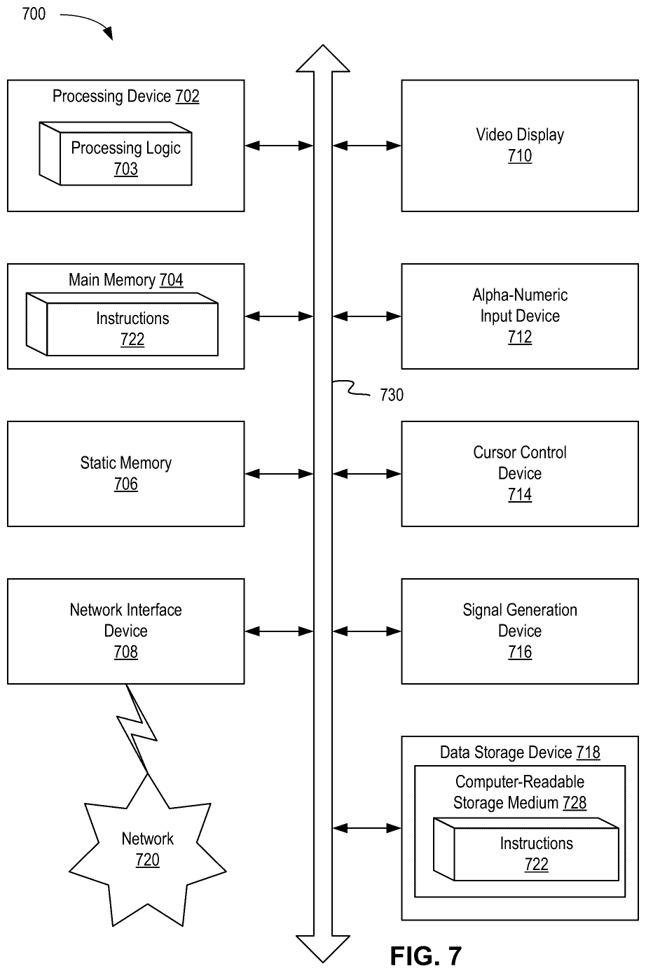

FIG. 7 depicts a block diagram of an example computer device 700 capable of supporting deployment of a frame processing pipeline that eliminates frame tears, reduces stutters, and minimizes latency, according to at least one embodiment. Example computer device 700 can be connected to other computer devices in a LAN, an intranet, an extranet, and/or the Internet. Computer device 700 can operate in the capacity of a server in a client-server network environment. Computer device 700 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 700 can include a processing device 702 (also referred to as a processor or CPU), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which can communicate with each other via a bus 730.

Processing device 702 (which can include processing logic 703) represents one or more general-purpose processing devices such as a microprocessor, central processing unit, or the like. More particularly, processing device 702 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 702 can be configured to execute instructions executing methods 500 and 600 of deployment of a frame processing pipeline deploying the techniques that eliminate frame tears, reduce stutters, and minimize latency, according to some embodiments of the present disclosure.

Example computer device 700 can further comprise a network interface device 708, which can be communicatively coupled to a network 720. Example computer device 700 can further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and an acoustic signal generation device 716 (e.g., a speaker).

Data storage device 718 can include a computer-readable storage medium (or, more specifically, a non-transitory computer-readable storage medium) 728 on which is stored one or more sets of executable instructions 722. In accordance with one or more aspects of the present disclosure, executable instructions 722 can include executable instructions executing methods 500 and 600 of deployment of a frame processing pipeline deploying the techniques that eliminate frame tears, reduce stutters, and minimize latency, according to some embodiments of the present disclosure.

Executable instructions 722 can also reside, completely or at least partially, within main memory 704 and/or within processing device 702 during execution thereof by example computer device 700, main memory 704 and processing device 702 also constituting computer-readable storage media. Executable instructions 722 can further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining.” “storing.” “adjusting,” “causing,” “returning.” “comparing,” “creating.” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having.” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g, executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing.” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
collecting one or more latency metrics associated with rendering a first set of one or more frames using a graphics rendering pipeline, the graphics rendering pipeline operating according to a first frame-generation schedule;
modifying, based at least on the one or more latency metrics, a first frame-generation schedule to obtain a second frame-generation schedule;
rendering, using the graphics rendering pipeline operating according to the second frame-generation schedule, a second set of one or more frames; and
causing the second set of frames to be displayed using a display device.

2. The method of claim 1, wherein the latency metrics comprise, for one or more frames of the first set of frames, at least one of:
a time-in-queue associated with a delay between rendering a respective frame and displaying the respective frame,
a duration of processing associated with rendering the respective frame.

3. The method of claim 1, wherein the first frame-generation schedule comprises a target time-in-queue for the first set of one or more frames.

4. The method of claim 3, wherein the target time-in-queue is determined in relation to an inverse refresh rate of the display device.

5. The method of claim 3, wherein the one or more latency metrics comprise a measured time-in-queue for at least one frame of the first set of one or more frames, and wherein modifying the first frame-generation schedule to obtain the second frame-generation schedule comprises:
modifying, using a difference between the measured time-in-queue and the target time-in-queue, at least one of:
a minimum interval associated with rendering consecutive frames of the second set of one or more frames, or
one or more starting times associated with rendering the second set of one or more frames.

6. The method of claim 5, wherein modifying the minimum interval comprises:
adjusting the minimum interval based at least on (i) the difference between the measured time-in-queue and the target time-in-queue and (ii) a number of frames of an adjustment period.

7. The method of claim 1, wherein the graphics rendering pipeline comprises:
a plurality of buffers, and
a controller configured to cause a rendered frame to be provided, to the display device, from an individual buffer from the plurality of buffers conditional on the rendered frame being stored using the individual buffer.

8. The method of claim 1, further comprising:
determining that a frame of the first set of frames has not been rendered in time for displaying on the display device; and
rendering a previous frame of the first set of frames for an extra period of time.

9. The method of claim 8, wherein the second frame-generation schedule is accelerated compared with the first frame-generation schedule, and wherein the method further comprises:
discarding a frame after the second set of one or more frames has been displayed on the display device.

10. The method of claim 1, wherein the first frame-generation schedule is determined based at least on a refresh rate of the display device.

11. The method of claim 1, wherein the first set of frames and the second set of frames are associated with at least one of a gaming application, a streaming application, a content streaming application, or a collaborative content creation application.

12. A processing device to:
collect one or more latency metrics associated with rendering a first set of one or more frames using a graphics rendering pipeline, the graphics rendering pipeline operating according to a first frame-generation schedule;
modify, using the one or more latency metrics, a first frame-generation schedule to obtain a second frame-generation schedule;
render, using the graphics rendering pipeline operating according to the second frame-generation schedule, a second set of one or more frames; and
cause the second set of frames to be displayed using a display device.

13. The processing device of claim 12, wherein the latency metrics comprise, for one or more frames of the first set of frames, at least one of:
a time-in-queue associated with a delay between rendering a respective frame and displaying the respective frame,
a duration of processing associated with rendering the respective frame.

14. The processing device of claim 12, wherein the first frame-generation schedule comprises a target time-in-queue for the first set of one or more frames, and wherein the target time-in-queue is determined in relation to an inverse refresh rate of the display device.

15. The processing device of claim 14, wherein the latency metrics comprise a measured time-in-queue for at least one frame of the first set of one or more frames, and wherein to modify the first frame-generation schedule to obtain the second frame-generation schedule, the processing device is to:
modify, using a difference between the measured time-in-queue and the target time-in-queue, at least one of:
a minimum interval associated with rendering of consecutive frames of the second set of one or more frames, or
one or more starting times associated with rendering of the second set of one or more frames.

16. The processing device of claim 15, wherein modifying the minimum interval comprises:
adjusting the minimum interval based at least on (i) the difference between the measured time-in-queue and the target time-in-queue and (ii) a number of frames of an adjustment period.

17. The processing device of claim 14, wherein the graphics rendering pipeline comprises:
a plurality of buffers, and
a controller configured to cause a rendered frame to be provided, to the display device, from an individual buffer from the plurality of buffers conditional on the rendered frame being fully stored in the individual buffer.

18. The processing device of claim 14, wherein the processing device is further to:
determine that a frame of the first set of frames has not been rendered in time for display using the display device; and
render a previous frame of the first set of frames for an extra period of time; and discard a frame after the second set of one or more frames has been displayed on the display device, and wherein the second frame-generation schedule is accelerated compared with the first frame-generation schedule.

19. The processing device of claim 14, wherein the processing device is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system for generating or presenting at least one of augmented reality content, virtual reality content, or mixed reality content;
a system implemented using a robot;
a system for performing conversational AI operations;
a system for generating synthetic data using AI operations;
a system incorporating one or more virtual machines (VMs);
a system implemented at least partially in a data center; or
a system implemented at least partially using cloud computing resources.

20. A system comprising:
a plurality of processing units to collect one or more latency metrics associated with rendering of a first set of one or more frames using a graphics rendering pipeline operating according to a first frame-generation schedule, modify a first frame-generation schedule using the one or more latency metrics to obtain a second frame-generation schedule, render a second set of one or more frames using the graphics rendering pipeline operating according to the second frame-generation schedule, and cause the second set of frames to be displayed using a display device.
